(19) United States
(12) Patent Application Publication
(10) Pub. No.: US 2004/0074698 A1
(43) Pub. Date: Apr. 22, 2004

(54) Removable tread mat for open riser stairs

(76) Inventor: Richard William Lawrence, Indianapolis, IN (US)

Correspondence Address: Bruce J. Bowman, Maginot, Moore & Bowman, Bank One Center/Tower, 111 Monument Circle, Suite 3000, Indianapolis, IN, 46204-5115, US

(21) Appl. No.: 10/277,406

(22) Filed: Oct. 22, 2002

(51) Int. Cl. E06C 1/00

(52) U.S. Cl. 182/129; 182/230

(57) ABSTRACT

A stair mat for a tread of a step includes a textured material such as corrugated, polypropylene carpet having a non-skid backing material such as rubber The stair mat is flexible and is adapted to surround the tread 16 such that the textured material extends 360° about the tread. The stair mat includes a closure such as Velcro® that is formed as a hook strip disposed on one side of the mat adjacent a first longitudinal end, and a loop strip disposed on another side of the mat adjacent a second longitudinal end.

### BACKGROUND

1. Field of the Invention

The present invention relates generally to coverings for stair steps and, more particularly, to a removable mat for step treads of a stair.

2. Background Information

Stairs consist of steps retained by side supports. A step typically consists of a horizontal member or tread and a vertical member or riser. In some instances stairs are constructed without risers. Therefore, the steps consist of only treads supported on each side by a support. The stair treads may be made from a variety of materials including wood, stone, plastic or other natural and man-made material. In all cases, it has been found advantageous to provide a tread covering. A tread covering can provide a safety aspect associated with the use of the stairs. This is especially true of stairs that are exposed to the elements such as stairs for recreational vehicles (RVs), trailers, campers, boats, docks, and the like.

In response to the above-identified problem, various solutions have been developed. Typical tread coverings include carpet, rubber, or the like that is placed on the stair tread. One such step cover is illustrated in U.S. Pat. No. 115,717 issued to Dieterich et al. on Jun. 6, 1871 (hereinafter “the '717 patent”). The '717 patent provides a step cover consisting of a sheet or slab of vulcanized rubber or gutta-percha beveled on all four edges and contained within a frame. The frame is composed of overlapping and beveled strips that are secured together by screws. The step cover of the '717 patent, however, is disadvantageous for various reasons including the fact that it covers only the top side of the step and is secured to the step by screws.

In U.S. Pat. No. 161,305 issued to Walter on Mar. 23, 1875 (hereinafter “the '305 patent”) there is disclosed a stair pad having a strip of carpet in a frame. The frame has a curved front edge that wraps over the curved edge of a step. Again, the stair pad of the '305 patent is disadvantageous for various reasons including those described above with respect to the '717 patent. In a similar manner, U.S. Pat. No. 815,391 issued to Weinstock on Mar. 20, 1906 (hereinafter “the '391 patent”), discloses a stair carpet holder having a frame with a biased hook on the front thereof for engaging the front stair edge. The stair carpet holder of the '391 patent, however, suffers from at least the same disadvantages as the others.

U.S. Pat. No. 6,088,976 issued to Roy on Jul. 18, 2000 (hereinafter “the '976 patent”) discloses a removable non-skid step pad. The step pad includes a pad that is fastened around the stair tread. The pad portion of the '976 patent, however, does not extend about the entire tread and is designed to be placed on the tread in a specific manner that cannot be reversed.

In view of the above, it would be advantageous to provide a stair mat that has a textured stepping surface that extends entirely around the tread.

It would be further advantageous to provide a stair mat as indicated above that has a non-skid bearing surface that extends entirely about the tread, particularly in conjunction with the stepping surface.

### SUMMARY

In accordance with the invention, there is provided a mat for a tread of a stair step wherein the step does not have a corresponding riser. The mat has a textured stepping surface that extends entirely around the tread. The mat is secured to itself once wrapped around the tread. Hook and loop fasteners are preferably used to secure one end of the mat with another.

The mat preferably consists of a textured (e.g. corrugated) indoor-outdoor type carpet as the stepping surface such as a polypropylene carpet. The carpet includes a backing that consists of at least one layer of a rubber or similar elastomeric that provides a non-slip surface. The backing naturally also extends entirely around the tread and is adapted to be in contact with the tread surface.

In one form, the subject invention is a mat for a stair tread. The mat includes a length of textured material having a first end and a second end, a backing material on one side of the textured material, and a closure formed as a first part disposed on a first end of the textured material and a second part disposed on the backing material on a second end opposite said first end. The closure securing the length of textured material onto a stair tread wherein the textured material extends 3600 about the stair tread.

In another form, the subject invention is a mat for a tread of a riser-less stair. The mat includes a length of corrugated carpet defining a top surface, a bottom surface, a longitudinal length having first and second ends, and a short length having third and fourth ends. The longitudinal length of corrugated carpet is sufficient to extend entirely around a short length of the stair tread when installed on the stair tread. A non-skid material is disposed on the bottom surface of the corrugated carpet. A fastener is associated with the corrugated carpet and the non-skid material and is adapted to releasably hold the corrugated carpet around the stair tread.

In another form, the subject invention is a mat for a riser-less step tread. The mat includes a length of polypropylene carpet having an underside surface and first and second longitudinal ends, a rubber backing disposed on the underside surface, and a releasable fastener having a first strip of first fastening material disposed on the polypropylene carpet at the first longitudinal end, and a second strip of second fastening material complementary to the first fastening material disposed on the backing at the second longitudinal end. The fastener allowing the polypropylene carpet to wrap around the tread and be secured thereon, wherein the polypropylene carpet creates a 360° surface around the tread.

### BRIEF DESCRIPTION OF THE DRAWINGS

In the drawings:

FIG. 1 is a perspective view of a flight of exemplary stairs on which the subject invention may be utilized;

FIG. 2 is an enlarged side view of an exemplary embodiment of a mat made in accordance with the principles of the subject invention;

FIG. 3 is a top plan view of the exemplary mat of FIG. 2 with one corner folded down to better illustrate the various features of the subject invention;

FIG. 4 is a side view of the exemplary mat of FIG. 2 illustrating the manner in which the mat is installed on a stair tread;

FIG. 5 is a perspective view of the stairs of FIG. 1, with each tread having the subject mat installed thereon; and

FIG. 6 is a sectional view of one of the treads of the stairs of FIG. 4 taken along line 6-6 thereof showing a mat installed thereon.

Corresponding reference characters indicate corresponding parts throughout the several views.

### DESCRIPTION OF THE PREFERRED EMBODIMENT

Referring to FIG. 1, there is depicted an illustration of an exemplary flight of stairs generally designated 10 in which the subject invention may be used. It should be appreciated that the stairs 10 is only exemplary of the many types of stairs that can utilize the subject invention as described herein. While the stairs 10 is shown by itself, it should be appreciated that the stairs 10 may be part of or attached to a structure such as an RV, mobile home, camper, dock or the like.

The stairs 10 includes a first side support, stringer or the like 12 and a second side support, stringer or the like 14. Situated between the first and second side supports 12 and 14 is a plurality of treads 16 forming steps. The stairs 10, and particularly the treads 16 do not have risers associated therewith. Thus the stairs 10 may be considered an open-tread stair or a riser-less stair. It should be appreciated that the subject invention is thus applicable to any type of open-tread or riser-less stair. Moreover, it should be appreciated that the number of steps or treads 16 in the flight of stairs 10 is irrelevant. The subject invention is applicable equally to a single step and a stair having a plurality of steps.

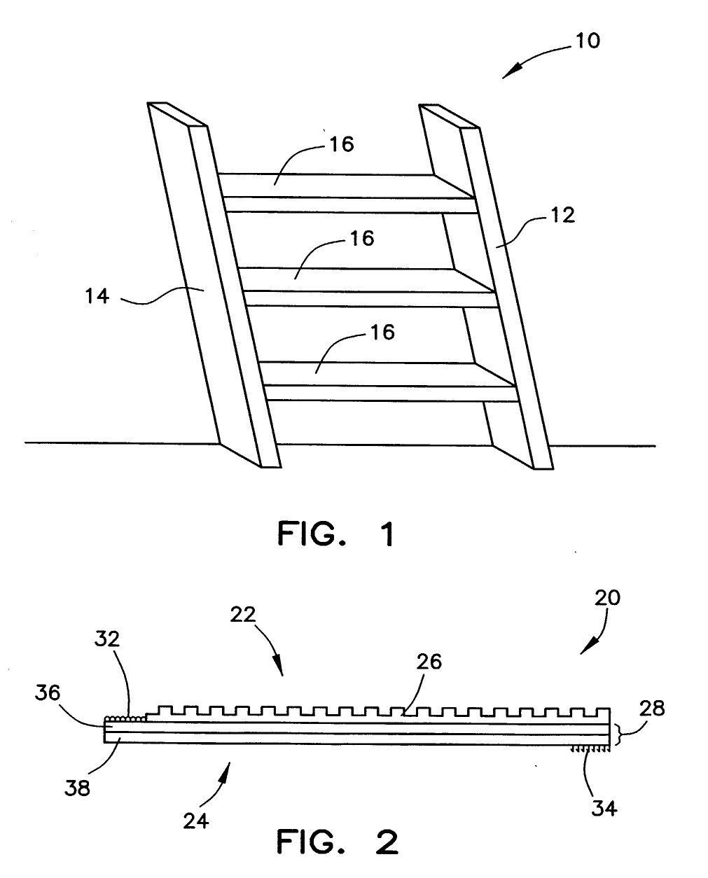

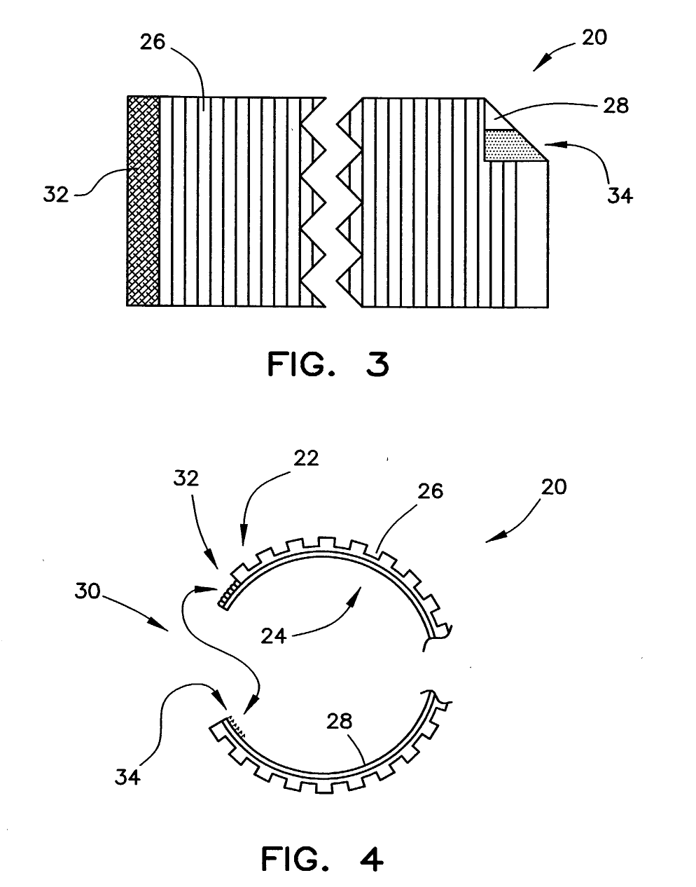

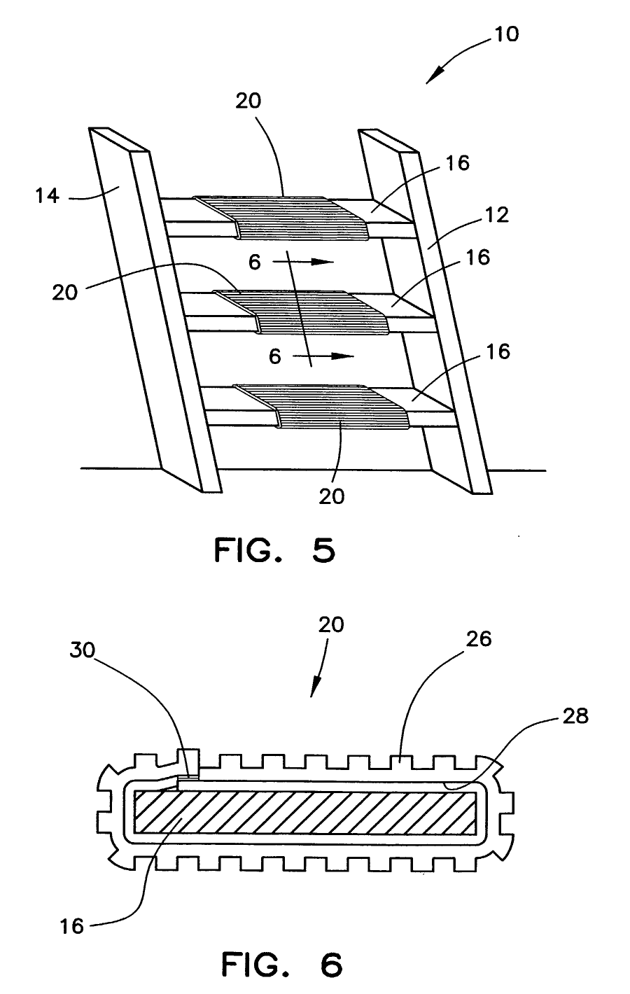

Referring to FIGS. 2 and 3, an exemplary embodiment of a mat, generally designated 20, in accordance with the principles of the subject invention is shown. The mat 20 has an outer surface 22 and an inner surface 24. The outer surface 22 provides a stepping surface while the inner surface 24 provides a backing, contact or bearing surface. When installed on a tread as shown in FIGS. 4 and 5 and described below, the stepping surface 22 faces outward relative to the tread 16 while the contact surface 24 faces inward relative to the tread 16.

The stepping surface 22 is preferably formed of a textured material 26 that is preferably at least somewhat weatherproof or impervious to weather (e.g. rain, sleet, snow, sunshine, etc.). The textured material 26 is also preferably relatively easy to clean and is durable. One such material may be an indoor/outdoor type carpet such as a polypropylene carpet. In one form, the stepping surface 22 is formed of a corrugated polypropylene carpet. Of course, other carpets and/or materials may be used.

The contact surface 24 is preferably formed of a non-skid material 28. The non-skid material 28 forms a backing for the textured material 26. The non-skid material 28 may be a rubber, elastomeric or other type of non-skid material that provides a positive traction (non-slip) surface. In one form as shown, the non-skid material 28 may consist of multiple plies 36, 38 of material (having two or more layers). One ply 36 may be an underlayment such as roping, cording, or the like that provides a good foundational material. A second ply 38 may be an elastomeric or other non-skid material. Of course, the backing 28 may be formed of a single material, a single layer of a composite material, or the like.

The mat 20 further includes a first retention portion 32 and a second retention portion 34. The first and second retention portions 32 and 34 together form a releasable fastener 30 (see FIG. 4) that allows the mat 20 to join ends to thus be securely installed on a stair tread, and to easily release the two ends to uninstall (remove) the mat from the stair tread. In a preferred form, the fastener 30 comprises a loop portion and a hook portion. It should be appreciated that while the first portion 32 is depicted as the loop portion and the second portion 34 is depicted as the hook portion, the two are interchangeable.

The loop portion 32 may constitute a strip of loop material that is applied to the textured material 26. The hook portion 34 may constitute a strip of hook material that is applied to the backing 28. Preferably, and as best seen in FIG. 3, the first (loop) portion 32 preferably extends at least, but not necessarily, substantially from one short side of the mat 20 to another short side of the mat 20. The second portion 34 also preferably extends at least, but not necessarily, substantially from one short side of the mat 20 to another short side of the mat 20. It should be appreciated that the mat 20 in FIG. 3 has one corner folded over in order to clearly illustrate the position and configuration of the second (hook) portion 34.

Referring to FIG. 4, the mat 20 is depicted being folded together as is done when the mat 20 is installed on a stair tread 16. As the mat 20 is bent or folded around the tread 16, the first and second portions 32 and 34 join. The mat 20 is thus formed into a continuous loop. Moreover, as the first and second portions 32 and 34 are releasably joined, the textured material 26 extends 360° about the mat 20. As well, the backing material 28 extends 3600 about the mat 20.

In FIG. 5, there is depicted the exemplary flight of stairs 10 as first depicted in FIG. 1. In FIG. 5, each tread 16 has a mat 20 disposed thereon. As indicated above, the textured material 26 extends entirely around the short length of the tread 16 but not necessarily its length. The length may be variable both due to different size steps and desired amount of tread coverage. In this manner, if the mat 20 rotates on the tread 16 either intentionally or not, the textured material 26 always presents itself on the top of the tread 16.

The mat 20 may be manufactured in various sizes, colors, stepping materials, and the like. Various designs may be incorporated into the stepping material. Each mat may cover a given amount of stair tread to accommodate various step sizes.

FIG. 6 shows a sectional view of the mat 20 installed on the tread 16. It can be clearly seen that the textured material 26 extends 3600 around the short length of the tread 16 while the amount of the long length of the tread 16 that may or may not be covered depends on the size of the mat 20. As well, the backing material 28 also extends 360° around the short length of the tread 16.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

What is claimed is:

1. A mat for a stair tread comprising:
a length of textured material having a first end and a second end;
a backing material on one side of the textured material; and
a closure formed as a first part disposed on a first end of said textured material and a second part disposed on said backing material on a second end opposite said first end;
said closure securing said length of textured material onto a stair tread wherein said textured material extends 3600 about the stair tread.

2. The mat according to claim 1, wherein said textured material comprises polypropylene carpet.

3. The mat according to claim 2, wherein said polypropylene carpet is corrugated.

4. The mat according to claim 1, wherein said backing material is non-skid.

5. The mat according to claim 4, wherein said non-skid material is an elastomeric.

6. The mat according to claim 1, wherein said fastener comprises Velcro®.

7. The mat according to claim 1, wherein:
said first part comprises a first strip of one of a loop material and a hook material, said first strip extending substantially a short length of said textured material; and
said second part comprises a second strip of another one of said loop material and said hook material, said second strip extending substantially a short length of said backing material.

8. The mat according to claim 7, wherein said fastener is releasable.

9. A mat for a tread of a riser-less stair, the mat comprising:
a length of corrugated carpet defining a top surface, a bottom surface, a longitudinal length having first and second ends, and a short length having third and fourth ends, said longitudinal length of corrugated carpet sufficient to extend entirely around a short length of the stair tread when installed on the stair tread;
a non-skid material disposed on said bottom surface of said corrugated carpet; and
a fastener associated with said corrugated carpet and said non-skid material and adapted to releasably hold said corrugated carpet around the stair tread.

10. The mat according to claim 9, wherein said corrugated carpet comprises corrugated polypropylene carpet.

11. The mat according to claim 9, wherein said non-skid material is an elastomeric.

12. The mat according to claim 11, wherein said elastomeric comprises rubber.

13. The mat according to claim 9, wherein said fastener is formed as a first part disposed on a first end of said corrugated carpet and a second part disposed on said backing material on a second end opposite said first end.

14. The mat according to claim 13, wherein said first part comprises a first strip of one of a loop material and a hook material, said first strip extending substantially a short length of said textured material; and
said second part comprises a second strip of another one of said loop material and said hook material, said second strip extending substantially a short length of said backing material.

15. The mat according to claim 14, wherein said fastener is releasable.

16. A mat for a riser-less step tread comprising:
a length of polypropylene carpet having an underside surface and first and second longitudinal ends;
a rubber backing disposed on said underside surface; and
a releasable fastener having a first strip of first fastening material disposed on said polypropylene carpet at said first longitudinal end, and a second strip of second fastening material complementary to said first fastening material disposed on said backing at said second longitudinal end;
wherein said fastener allows said polypropylene carpet to wrap around the tread and be secured thereon, said polypropylene carpet creating a 360° surface around the tread.

17. The mat according to claim 16, wherein said polypropylene carpet is corrugated.

18. The mat according to claim 16, wherein said first strip extends substantially a short length of said first longitudinal end and comprises one of a loop material and a hook material; and
said second strip extends substantially a short length of said second longitudinal end and comprises another one of said loop material and said hook material.

19. The mat according to claim 18, wherein said fastener comprises Velcro®.
